(19) United States
(12) Patent Application Publication
(10) Pub. No.: US 2011/0180285 A1
(43) Pub. Date: Jul. 28, 2011

(54) IMPLEMENT HAVING AN OVERRUNNING CLUTCH

(75) Inventor: Helmut Braun, Bergkirchen (DE)

(73) Assignee: Wacker Neuson SE, Munich (DE)

(21) Appl. No.: 13/056,195

(22) PCT Filed: Oct. 5, 2009
(86) PCT No.: PCT/EP2009/007111

§ 371 Date: Jan. 27, 2011

(30) Foreign Application Priority Data
Oct. 7, 2008 (DE) 10 2008 050 703.2

(51) Int. Cl. B23Q 5/00

(52) U.S. Cl. 173/18

(57) ABSTRACT

An implement having a drive, a drive element that may be driven by the drive and that is disposed in an axially moveable manner and is coupled to the drive element, and an overrunning clutch disposed in the drive or in a torque flux between the drive and the drive piston. If the drive has a movement that is slower than that of the drive element, the overrunning clutch is in an idle state, in which the clutch interrupts the torque flux between the drive and the drive element, thus decoupling the movement of the drive element from the drive torque of the drive. In this manner, the drive element may move more rapidly, for example during the return movement thereof, than would correspond to the movement forced by the drive.

### BACKGROUND OF THE INVENTION

1. Field of the Invention

This invention relates to an implement which lends itself to being used, for instance, in a demolition hammer, percussion drill, pavement breaker or a tamper for soil compaction.

2. Discussion of the Related Art

Implements in which the driving torque of a drive unit is transferred from a driver element to a motion element that is connected to the driver element have been generally known in prior art. For example, percussion assemblies integrated in demolition hammers, percussion drills and/or pavement breakers can be operated based on that concept.

The driver element in a percussion assembly of that nature is a drive piston which can be set in axially oscillating motion by a suitable drive unit such as a crank gear coupled to an electric motor. That axially oscillating motion can be transferred to a tool such as a power chisel. To avoid exposing the drive unit to excessive loads causing wear and tear and to enhance the percussive effect of the tool it is possible to position between the crank gear and the tool-holding fixture a motion element such as a percussion piston and to connect that to the drive piston via a spring element. A conventional approach, for example, has been the use of one-sided or double-sided pneumatic-spring percussion assemblies.

Pneumatic-spring percussion assemblies are generally differentiated by the design and positioning of a drive piston and a percussion piston. Specifically, there are four known variations of pneumatic-spring percussion assemblies:
One-sided percussion assemblies with a drive piston and a percussion piston of identical diameter, moving inside a percussion-mechanism enclosure;
one-sided percussion assemblies with a hollow drive piston that is open at one end and in which travels the percussion piston;
one-sided percussion assemblies with a hollow percussion piston that is open at one end and in which travels the drive piston; and
two-sided percussion assemblies with a hollow drive piston surrounding the percussion piston.

In these systems the drive piston and the percussion piston may be sealed relative to each other and, depending on the design variation, relative to the mechanism enclosure by means of a diaphragm gland or some other suitable seal, so that at high relative speeds between the drive piston and the percussion piston the enclosed volume of air can form pneumatic springs.

The following will describe the mode of operation of a conventional percussion assembly in one operating cycle.

By means of the crank gear the drive piston, meaning the driver element, can be set in an axially oscillating motion approximately along a sine function, where the extreme position of the drive piston facing the crank gear may be referred to as the upper dead center while its extreme position facing away from the crank gear may be referred to as the bottom dead center.

When the drive piston travels from the upper dead center in the direction of the bottom dead center and of the percussion piston, that being the motion element, a pneumatic spring is generated by the trapped volume of air between at least one front face of the percussion piston and the drive piston. Due to the inertia of the percussion piston the movement of the drive piston in the direction of the bottom dead center overcompresses the trapped air, thrusting the percussion piston in the direction of movement of the drive piston. There, an impact element

with an attached tool bit may be provided, constituted for instance of the end surface of the tool or of a die head. The thrust causes the percussion piston to strike the impact element, imparting linear momentum to the tool and then recoiling. The recoil is a function of the impact energy, the geometry of the constituent percussion components, the material of the strike element and the hardness of the targeted work piece. The kick-back will be particularly strong when the tool bit is wedged in the work piece. The recoil moves the percussion piston in the direction of the drive piston and away from the impact element.

The direction of travel of the drive piston that is connected to the crank gear is reversed the moment the drive piston reaches the bottom dead center. If the drive piston, now moving in the direction of the crank gear, travels at a speed greater than that of the percussion piston, the relative motion of the two pistons will generate negative pressure in the air chamber and thus a pneumatic spring that produces a suction effect on the percussion piston, boosting its return motion.

Upon reaching the upper dead center the drive piston (driver element) is again moved in the opposite direction by the crank gear while—due to the effect of the pneumatic spring now positioned between the pistons in the state of compression—braking the percussion piston (motion element) which is still in the return-movement mode, then once again accelerating the latter in the direction of the impact element, setting the stage for the next percussion cycle.

In the case of a percussion assembly of the conventional design described above, the recoiling of the tool against the percussion piston can negatively affect the relative movement between the drive piston and the percussion piston. For example, a powerful kick-back resulting from a hard object surface, a hard work piece, a wedged tool bit or a strong preceding stroke can cause the percussion piston to recoil with a high degree of kinetic energy.

In a pneumatic-spring percussion assembly this can have an effect whereby pressure builds up in the pneumatic spring between the percussion piston (motion element) and the drive piston (driver element) even as the drive piston is still on its way in the direction of the upper dead center. The percussion piston is slowed by that pressure, losing kinetic energy and in an extreme case it may even reverse direction. By the time the drive piston approaches the percussion piston, the percussion piston has already slowed down, and the pneumatic spring is no longer sufficiently reloaded, so that the drive piston can transfer only a weak thrust movement to the percussion piston. Conversely, the pneumatic spring could be loaded at a point in time when the drive piston begins to move in the direction of the percussion piston in relation to which, however, it is still too close to the upper dead center, so that it is moving at a slow rate. In this case as well the pneumatic spring is loaded less strongly than it would be when the percussion piston and the drive piston move toward each other in opposite directions at a high relative speed. Moreover, at the time of maximum pneumatic spring compression, the rate of speed of the drive piston is too low, resulting in a correspondingly weak stroke in the subsequent percussion cycle.

Similar effects can also be encountered with other types of implements in which the driving torque is transmitted by the respective driver element to an associated motion element, compromising the efficacy or physical performance of the implement.

### SUMMARY OF THE INVENTION

It is the objective of this present invention to introduce an implement in which the premature braking of the motion element can be prevented. Another objective of the invention is to introduce an implement with an improved movement pattern of the driver element and the motion element.

The stated objective is achieved by providing in implement including a drive unit, a driver element axially movable by the drive unit, a motion element axially movable and linked to the driver element via a coupling, and an overrunning clutch positioned in the drive unit or in a torque flow between the drive unit and the driver element;. The overrunning clutch is engaged in a locked state when the drive unit moves at a speed greater than or equal to that of the driver element, and in a disengaged state when the drive unit moves at a speed slower than that of the driver element. The torque flow between the drive unit and the driver element is closed in the locked state and interrupted in the disengaged state of the overrunning clutch.

An implement features a drive unit, a driver element axially movable by the action of the drive unit, an axially movable motion element that is connected to the driver element via a coupling such as a spring element, and an overrunning clutch positioned in the drive unit or in a torque flow between the drive unit and the driver element. The overrunning clutch is in a locked, engaged state when the drive unit moves at a speed greater than or equal to the movement of the driver element. The overrunning clutch is in a free-wheeling, disengaged state when the drive unit moves at a speed slower than that of the driver element. In its locked state the overrunning clutch closes the torque flow between the drive unit and the driver element. In its disengaged state the overrunning clutch interrupts the torque flow between the drive unit and the driver element.

The drive unit may include a motor such as an electric motor or a combustion engine. The drive unit can generate a driving torque that can encompass a translatory thrust component and/or a rotational torque component. That driving torque can be transferred to the driver element via other constituents of the drive unit such as flywheels, shafts and/or transmission gears as well as the overrunning clutch that is connected to the drive unit. The driver element may be in the form for instance of a drive piston.

The overrunning clutch can be in two different operating states. It will be in a locked, engaged state when the drive unit moves at a speed equal to or greater than that of the driver element. This would be the case for instance when the drive unit is accelerating the driver element. In its engaged state the overrunning clutch closes the torque flow between the drive unit and the driver element, allowing the kinetic energy generated by the drive unit to be transferred to the

driver element for instance in non-positive or positive fashion.

When the drive unit moves more slowly than the driver element, specifically meaning that the driver element is not accelerated by the drive unit, the overrunning clutch will be in the disengaged, free-wheeling state in which the torque flow between the drive unit and the driver element is interrupted. The interruption of the torque flow in the disengaged state thus interrupts the transfer of the driving torque and/or the propulsive power of the drive unit to the driver element.

When the overrunning clutch is in the locked, engaged state, the drive unit can set the axially movable driver element in motion. The motion of the driver element may be oscillating or translatory and, for instance by means of a spring element or a pneumatic spring, this motion can be transmitted to the motion element that is coupled to the driver element. The motion element on its part may be axially movable and by virtue of the transmission of the movement of the driver element its own motion will be oscillatory or translatory, permitting its use for instance as a percussion or tamping motion in a power tool.

The overrunning clutch can be positioned in the torque flow between the drive unit and the driver element. Alternatively it is equally possible to functionally integrate the overrunning clutch directly into the drive unit, or the overrunning clutch may be a self-contained module in the drive unit. As another alternative, the functionality of the overrunning clutch can be obtained by controlling the drive unit in a manner whereby it cannot transition into the generating mode. This is possible especially with an electric motor where, by means of an appropriate control, generative operation of the motor can be prevented in the event the motor shaft is driven

externally (in this case by the motion element). In the case of an asynchronous motor and a synchronous motor with a frequency converter this can be accomplished for instance by not running the motor at a frequency that differs from the rotor frequency. If in this case the shaft of the motor is externally driven by the rapidly moving motion element, the rotor can spin freely in the stator when the current that flows, or can flow, in the stator is smaller than the no-load current.

Coupling the driver element and the motion element for instance by means of a spring element leads to an elastic transmission of the kinetic energy and thus to a dynamic relative movement between the driver element and the motion element, as will be explained in more detail further below. Moreover, positioning the spring element between the driver element and the motion element can attenuate the kick-back of the motion element against the drive unit enough to avoid overloading the drive unit.

The degree of energy transfer and attenuation can be controlled by the configuration of the spring element. Suitable designs include mechanical or hydraulic spring units. Those commonly used are pneumatic springs that can form in hollow spaces between the driver element and the motion element as a result of the relative movement between these elements, provided the hollow spaces are adequately sealed.

The following will explain the functional operation of an implement according to this invention based on the dynamic movement of its components. Let it be assumed that a movement of the drive unit has shifted the overrunning clutch into the locked state, enabling the driver element to transition into a translatory movement, for instance away from the motion element. The spring element can transfer that movement to the motion element which, delayed by its inertia, is itself set in motion in the same direction as the driver element.

At the upper dead center the movement of the driver element reverses the direction of travel of the driver element. At that point in time, due to its inertia, the motion element will continue to move toward the driver element. The mutually opposite relative movement of the two elements will preload the spring element up to the point where the direction of travel of the motion element as well is reversed and the motion element is set in motion toward the far side of the driver element. That motion is reinforced by the movement of the driver element toward the motion element and by a relaxation of the spring element, causing the motion element to be pushed away from the driver element with a high level of kinetic energy. That high kinetic energy can be used for an operating cycle of the implement. If the implement is designed as a percussion assembly, it can strike an impact device such as an impact tool. If the implement is designed as a tamper, the kinetic energy can drive a rammer as used for instance in soil compaction.

Depending on the impact-related conditions such as the degree of hardness of the impact device and/or the object surface underneath the impact device or rammer, the percussive energy is now partly transmitted to the impact device or rammer and/or the object surface and partly reflected back to the motion element, causing the motion element to recoil at an energy level that may vary as a function of the hardness of the object surface.

In the case of a strong kick-back the motion element will recoil with high kinetic energy. At that moment the driver element may still be moving toward the motion element before reaching the bottom dead center, or by the action of the drive unit it may already have been set in motion away from the bottom dead center. The acceleration of the motion element can preload the spring element, allowing the high kinetic energy of the motion element to be transferred to the driver element.

The driving torque thus impinging on the driver element may be stronger in this case than the driving torque of the drive unit, whereby the driver element transfers to the overrunning clutch a more rapid movement than does the drive unit. This causes the overrunning clutch to shift into the disengaged state, interrupting the torque flow between the drive unit and the driver element. The movement of the driver element and of the motion element is thus decoupled from the drive unit, allowing the motion element to thrust the driver element in the direction of the upper dead center. Having been decoupled, the driver element can be freely accelerated and the acceleration is not impeded by a coupling to the drive unit as would be the case for instance in an electric-motor drive unit by its transition into a generative operating mode.

The energy expended in the process reduces the speed of the motion element and thus that of the driver element on its way to the upper dead center. As soon as the speed of the driver element is equal to or lower than the speed of the drive unit, the overrunning clutch can shift into the engaged, locked state, closing the torque flow between the drive unit and the driver element. The driver element and, coupled with it, the motion element can now once again be moved by the drive unit.

As soon as the driver element reaches the upper dead center, the drive unit will reverse its direction of travel. Initially, given its inertia, the motion element will continue to move toward the driver element until the increased preload of the spring element reverses the direction of travel of the motion element as well. By then the driver element may already be moving away from its upper dead center and may have been accelerated by the drive unit in the direction of the motion element. The kinetic energy of the driver element and the energy stored in the spring element can then move the motion element, with a high energy level, away from the driver element and into the next operating cycle.

By virtue of the disengaged state of the overrunning clutch as described above the moment of inertia of the drive unit can be decoupled from the driver element and the motion element. That allows the motion element to convert the energy of a strong recoil into an acceleration toward the driver element. Both the motion element and the driver element can thus use the recoil energy for an accelerated movement in the direction of the upper dead center. This reduces the braking effect of the drive unit on the driver element and the motion element that draws kinetic energy away from these elements.

Due to the unimpeded movement of the driver element a premature compression of the spring element can be prevented. The timing of maximum compression of the spring element can therefore be delayed, for instance to the point where the driver element has already reversed its direction of travel and is moving at high speed toward the motion element. Since the energy of the motion element is determined by the thrust of the driver element and the energy stored in the spring element, the impact may be greater in this case.

It follows that the disengaged state makes it possible to use the kick-back energy for the subsequent operating cycle. Moreover, the disengaged state permits the overall enhancement of the operating efficiency of the implement since, for one, the movement of the motion element will be more powerful after a strong recoil and, for another, the acceleration of the driver element and the motion element engendered by the recoil will increase the number of operating cycles for the same unchanged driving power. In addition, the decoupling of the drive unit from the movement of the driver element and the motion element after a strong kick-back will help protect the drive unit.

To enhance the functional effect of the overrunning clutch, the latter can be suitably positioned

in the torque flow between the drive unit and the driver element. In general, any location within the effective path between the source of the driving torque and the driver element is possible so long as it permits a decoupling of the driving torque of the drive unit from the driver element. In particular, the overrunning clutch may be positioned close to the driver element so as to decouple from the driver element the maximum possible number of components of the drive train that have an inertial effect on the driver element. This allows for as comprehensive as possible a utilization of the thrust intensity of the recoil for moving the driver element and the motion element.

In one embodiment the drive unit is a rotary drive. In addition, the embodiment contains in the torque flow between the rotary drive and the driver element a rotation converter such as a crank gear that converts a rotational movement of the rotary drive into an oscillating translatory movement. In this case the driver element can be activated by the rotation converter.

The rotary drive can encompass an electric motor such as a high-frequency three-phase motor or alternatively a combustion engine that sets a shaft in rotary motion. By way of additional mechanical components such as a gear system this rotary motion can be transferred to the overrunning clutch and from there to the rotation converter. The latter can convert the rotation of the rotary drive into the oscillating axial translatory movement of the driver element.

Depending on the configuration of the rotation converter it can produce for instance a translatory movement of the driver element between the upper and the bottom dead center which approximately corresponds to a time-based sine function. In that case the speed of the driver element will be highest when it is half-way between the upper and the bottom dead center. The

above-described time-delayed and spatially shifted occurrence of maximum compression in the spring element can take place at a point where the drive unit causes the driver element to travel at a relatively high speed in the direction of the bottom dead center. That in turn can lead to an effective acceleration of the motion element by the driver element.

In a variation of this embodiment, the overrunning clutch is positioned in the torque flow between the rotary drive and the rotation converter. This makes it possible in the locked state of the overrunning clutch to transfer the rotational movement of the drive unit to the rotation converter for instance via the crank gear. In the disengaged state the torque flow can be interrupted, allowing the rotation converter to be decoupled from the rotation of the drive unit.

In one embodiment a spring element, serving as a coupling device, is positioned between the driver element and the motion element. This permits an elastic coupling of the movements of the driver element and the motion element and thus an elastic transmission of the kinetic energy between the driver element and the motion element. The spring element may encompass for instance mechanical springs positioned between the driver element and the motion element on opposite end faces of the motion element.

In another embodiment the overrunning clutch is constituted of a free-wheeling mechanism. Depending on the relative direction of rotation on its driving end and, respectively, its take-off end, the free-wheeling mechanism will shift between its engaged and its disengaged state. The driving end in this case refers to the side of the free-wheeling mechanism facing the drive unit from which the driving torque of the drive unit is transferred to the free-wheeling mechanism. The take-off end refers to the side, connected to the driver element, by way of which the driving torque of the drive unit is transferred to the driver element. In its engaged state, the free-

wheeling mechanism couples the driving end and the take-off end in positive interlocking and conjugate fashion. In its disengaged state the free-wheeling mechanism decouples the driving end from the take-off end.

In a variation of this design concept, the free-wheeling mechanism employs a friction coupling, pinch rollers, a ratchet coupling, and/or a gear coupling. In a friction coupling, friction elements or clamp rollers consisting of out-of-round i.e. non-circular and non-spherical elements are positioned between circular cylindrical track rings. The track rings may be positioned around the axes of rotation to be coupled. In the engaged state the driving end and the take-off end can be locked together by a positive coupling of the track rings with the friction elements. In the pinch roller-type free-wheeling mechanism the inner track ring may hold an internal star plate featuring individually spring-loaded rollers in concave recesses. Depending on the relative direction of rotation the rollers can move freely, thus decoupling the inner and the outer track ring, or they are pushed into the concave pockets, thus coupling the track rings by the clamping effect of the pinch rollers. In the case of a ratchet coupling as used for instance in ratchet wheels and ratchet spanners, the engaged state will establish a positive connection between the driving end and the take-off end. In the case of a gear coupling, cogs serve to transfer the torque. The gear-type free-wheeling mechanism will shift automatically when a difference in the speed of rotation between the driving end and the take-off end displaces a coupling sleeve.

In another embodiment, a fluid coupling can assume the functional role of the overrunning clutch. For example, if a check valve is integrated in the pump circuit, the resulting resistance will be high for the locking effect and low for the disengaged free-running effect.

As already stated above, the implement may be so configured that the overrunning clutch is directly integrated into the drive unit. In that case the drive unit will have to be designed for instance in a manner whereby in an operating mode in which a drive shaft of the drive unit is

powered by an external torque, the drive unit cannot be operated generatively, meaning that it cannot produce any output. The drive shaft and for instance a rotor connected to it can rotate freely whenever the motion element tries to overtake the driver element, without any electrical or magnetic fields being applied between the rotor and a stator of the drive unit. It is possible, for example, to turn off the excitation field in an asynchronous motor when an external source is to rotate the drive shaft at a speed greater than that set by the motor. It is thus unnecessary to provide a self-contained overrunning clutch module. Instead, appropriate control of the motor will create the overrunning clutch through direct interaction between the rotor and the stator.

In one embodiment the motion element is a percussion piston. In that design the implement can incorporate a percussion assembly to drive for instance a demolition hammer, a percussion drill, and/or a pavement breaker.

In a variation of that design the spring element may be in the form of at least one or of several pneumatic springs. The pneumatic springs may be produced by volumes of air trapped between the driver element and the percussion piston during their relative movement. By means of a positive or negative pressure effect they can transfer relative movements between the driver element and the percussion piston.

Another design variation incorporates an impact element that can be struck by the percussion piston. The impact element may be positioned in a manner whereby the percussion piston in its oscillating translatory movement will strike it at regular intervals. It may be in the form of a die head or the chuck of a tool bit. Alternatively, the tool holder may hold a tool in a manner whereby the percussion piston strikes the tool directly.

An implement according to the invention can be used in different ways. In one embodiment it is equipped with a tool that is attached to the impact element. The tool could be for instance the chisel of a pavement breaker that is operated by the repetitive impact of the percussion piston, meaning the motion element. Alternatively, the tool attached to the impact element may be a demolition hammer or a percussion drill operated by the percussion piston.

In another embodiment the implement is a vibrating tamper whose motion element is a ramming piston. The ramming piston may be equipped with a rammer butt that can be set in a tamping motion through the movement of the ramming piston. This action can be employed for instance in soil compaction.

In a variation of this embodiment the spring element is constituted of a helical spring that couples the movements of the driver element and the ramming piston and transfers them in reciprocating fashion. By means of the helical spring the high kinetic energy generated by the movement of the ramming piston and the rammer butt, which can have a substantial mass, can be suitably transferred between the driver element and the ramming piston. As an alternative or in addition, other types of spring elements such as gas-pressure springs or elastomer springs may be used.

In another variation of this embodiment the ramming piston features a cavity that accommodates the helical spring, gas-pressure spring and/or elastomer spring connected to the driver element. This allows for a suitable coupling of the movements of the driver element and the ramming piston and helps guide their axial movements while at the same time saving space.

These and other characterizing features of the invention are explained in more detail below, describing examples with the aid of drawings in which:

### BRIEF DESCRIPTION OF THE DRAWINGS

FIG. 1 shows a percussion assembly with free-wheeling mechanism and a simple pneumatic spring;

FIG. 2 shows a percussion assembly with free-wheeling mechanism and dual pneumatic springs;

FIG. 3 schematically illustrates a friction-type free-wheeling mechanism;

FIG. 3B shows a section of the friction-type free-wheeling mechanism in the disengaged state; and

FIG. 3C a section of the friction-type free-wheeling mechanism in the locked state.

FIG. 4 shows a tamper with free-wheeling mechanism and dual-action helical spring.

### DETAILED DESCRIPTION OF THE PREFERRED EMBODIMENTS

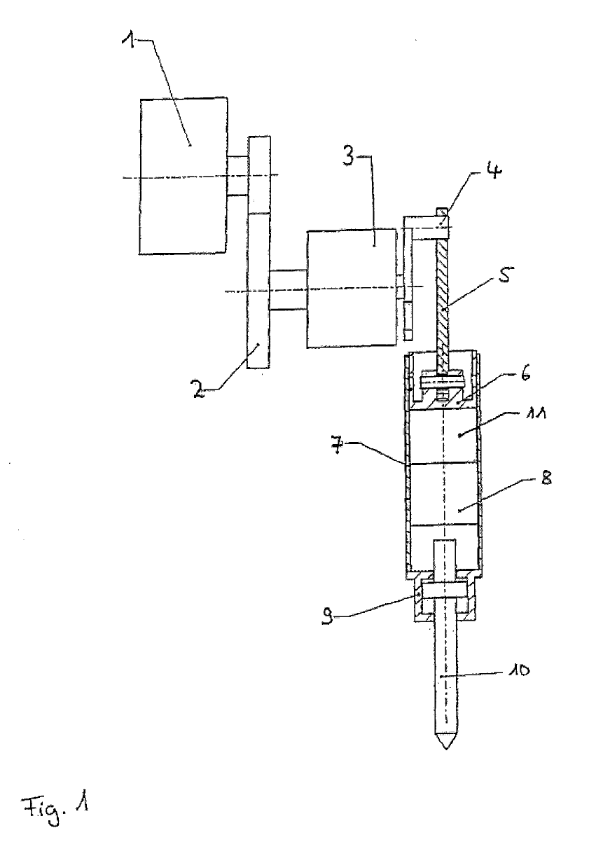

The percussion assembly schematically illustrated in FIG. 1 is driven by a motor 1 whose torque is transferred to a free-wheeling mechanism 3 via a gear system 2.

Depending on the operating state, free-wheeling mechanism 3 can transfer the torque received at its driving end to a rotation converter positioned at its take-off end which in FIG. 1 is composed of a crank gear 4 and a connecting rod 5. Crank gear 4 and connecting rod 5 convert the torque transmitted by the free-wheeling mechanism 3 into an oscillating translatory movement of a drive piston 6 that is linked to connecting rod 5.

Drive piston 6 moves within a hollow guide cylinder 7. Also moving within guide cylinder 7 is a cylindrical percussion piston 8 positioned on the far side of drive piston 6 away from connecting rod 5. Percussion piston 8 is so positioned that, on the side of guide cylinder 7 facing away from crank gear 4, it can strike a tool 10 that is mounted in a tool holder 9.

Both drive piston 6 and percussion piston 8 can move axially along the center axis of guide cylinder 7 and are sealed from guide cylinder 7 by means of diaphragm glands. These diaphragm glands make it possible during high relative speeds between drive piston 6 and percussion piston 8 for the volume of air enclosed between drive piston 6 and percussion piston 8 to form a pneumatic spring 11 by compression or decompression, permitting an elastic pulse transfer between drive piston 6 and percussion piston 8.

The following will describe, by the example of one impact cycle, the operation of the percussion assembly with free-wheeling mechanism and a simple pneumatic spring:

Upon the transfer of a given torque from motor 1 via gear system 2 to the driving end of free-wheeling mechanism 3, free-wheeling mechanism 3 will shift into its engaged, locked state if at that juncture crank gear 4 on the take-off side of free-wheeling mechanism 3 is running at a slower speed. In the locked state, free-wheeling mechanism 3 transfers the torque to crank gear 4, thus setting it in motion. By way of connecting rod 5 the rotation is converted into an oscillating translatory motion of drive piston 6 along the center axis of guide cylinder 7. In the position of the components of the percussion assembly shown in FIG. 1, this will cause drive piston 6 to move for instance in the direction of percussion piston 8. As a result, pneumatic spring 11 enclosed in guide cylinder 7 between drive piston 6 and percussion piston 8 will be compressed and the kinetic impulse of drive piston 6 will be elastically transferred to percussion piston 8. Percussion piston 8, delayed by its inertia, will on its part be set in motion in the direction corresponding to the travel of drive piston 6 and toward tool 10. It strikes tool 10 which relays the impact energy thus received to an object surface, not shown, or to a work piece, not illustrated. Depending on the degree of hardness of the work piece and of tool 10,

percussion piston 8 will be kicked back in the direction of drive piston 6. At that point in time, depending on the rotational speed of motor 1, drive piston 6 may still be moving in the direction of percussion piston 8 or, following arrival at the bottom dead center, it may already have been caused by crank gear 4 and connecting rod 5 to move in the opposite direction.

The recoil energy of the kick-back accelerates percussion piston 8 in the direction of drive piston 6, in the process compressing pneumatic spring 11 enclosed between drive piston 6 and percussion piston 8 and consequently allowing the acceleration energy to be elastically transferred to drive piston 6. Connecting rod 5 will now convert the linear, axial motion of drive piston 6 into a rotary motion of crank gear 4, transferring it to the take-off end of free-wheeling mechanism 3. If crank gear 4 rotates at a speed greater than that transferred by motor 1 and gear system 2 from the driving end to free-wheeling mechanism 3, free-wheeling mechanism 3 will shift into its disengaged state in which the torque flow between its driving and take-off ends is interrupted. The movement of drive piston 6 is thus decoupled from the drive unit of motor 1 and percussion piston 8 will be able to accelerate drive piston 6 in the direction of the kick-back.

As percussion piston 8 slows down, the movement of drive piston 6 and thus that of crank gear 4 will decelerate. As soon as the rotational speed transferred by crank gear 4 to the take-off end of free-wheeling mechanism 3 is slower than or equal to the rotational speed transferred by motor 1 via gear system 2 to the driving end of free-wheeling mechanism 3, free-wheeling mechanism 3 will again shift back into its locked state and motor 1 can impel the movement of drive piston 6.

If at that point in time drive piston 6 is still moving away from percussion piston 8, pneumatic spring 11 will be decompressed. The suction effect thus generated will elastically

transfer the kinetic impulse of drive piston 6 to percussion piston 8.

As soon as the direction of travel transferred to drive piston 6 by crank gear 4 and connecting rod 5 is reversed, an opposite relative movement between drive piston 6 and percussion piston 8 will be generated, once again compressing pneumatic spring 11 and initiating the next percussion cycle.

Since due to the effect of free-wheeling mechanism 3, drive piston 6 is decoupled from the torque of motor 1 while due to the recoil effect it can be freely accelerated, it will be in an advanced position at the beginning of the next following percussion cycle. Maximum compression of the pneumatic spring is therefore possible at a point in time when drive piston 6 has already been set in motion and accelerated in the direction of percussion piston 8. As a result, at the point of maximum pneumatic spring compression, drive piston 6 will be traveling at high speed in the direction of percussion piston 8, permitting substantial acceleration of percussion piston 8 with a correspondingly strong subsequent impact of percussion piston 8 on tool 10.

The recoil energy can thus be used for the next strike. Moreover, the impact capacity of the percussion assembly will be enhanced since the interpolation of free-wheeling mechanism 3 increases the number of strikes of the percussion assembly with an unchanged speed of rotation of the motor 1.

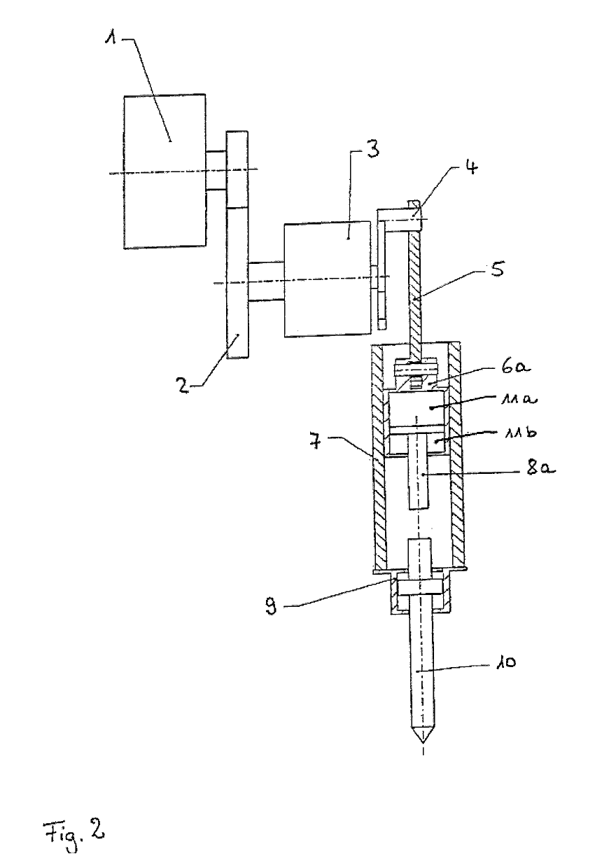

FIG. 2 shows a percussion assembly with a free-wheeling mechanism and a dual pneumatic spring. The functionalities of motor 1, gear system 2, free-wheeling mechanism 3, crank gear 4, and connecting rod 5 are the same as those described above.

In FIG. 2, drive piston 6a is cylindrical in shape and features a hollow space accommodating a percussion piston 8a that moves linearly along the center axis of drive piston 6a.

Percussion piston 8a protrudes from drive piston 6a on its far end facing away from connecting rod 5, thus enabling it during a striking motion to impact the tool that is firmly mounted on tool holder 9. Drive piston 6a and percussion piston 8a are sealed from each other by diaphragm glands in a manner whereby during a relative movement between the two pistons the amounts of air enclosed inside drive piston 6a are compressed or decompressed on both sides of percussion piston 8a. Generated in the process is a first pneumatic spring 11a on the side of percussion piston 8a facing away from tool 10 and a second pneumatic spring 11b on the side of percussion piston 8a facing tool 10. The two pneumatic springs 11a and 11b permit an efficacious transfer of the kinetic energy between drive piston 6a and percussion piston 8a.

As in the case of the percussion assembly depicted in FIG. 1, it is possible in the percussion assembly shown in FIG. 2, after the acceleration of percussion piston 8a as a result of the kick-back transferred by tool 10 to percussion piston 8a, for free-wheeling mechanism 3 to interrupt the torque flow between motor 1 and drive piston 6a, thus allowing percussion piston 8a to freely accelerate drive piston 6a.

Moreover, in the percussion assembly illustrated in FIG. 2 the movement of drive piston 6a can be decoupled from motor 1 when percussion piston 8a is traveling with high kinetic energy in the direction of tool 10 while accelerating drive piston 6a by compressing pneumatic spring 11b. This will prevent percussion piston 8a from being slowed down by a coupling to the torque flow of the drive unit just before impact.

In the percussion assembly shown in FIG. 2, with a free-wheeling mechanism and dual pneumatic spring, the recoil energy can thus be used for preparing the next strike while increasing the number of strikes with an unchanged speed of rotation of the motor 1.

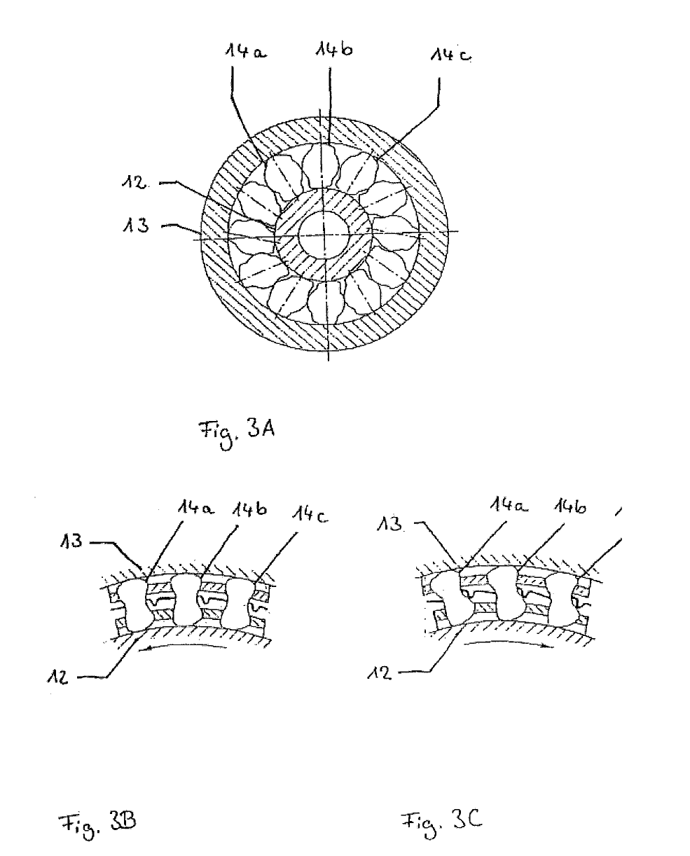

FIG. 3A is a schematic illustration of a friction-coupling-equipped free-wheeling mechanism with an internal drive ring and, concentric therewith, an external take-off ring 13, with non-circular friction-type clamping elements 14a, 14b, 14c etc. positioned between drive ring 12 and take-off ring 13. Depending on the orientation of the cross sectional cut through one of these friction elements 14a, 14b, 14 c . . . the diameter along that cut will vary. As a function of the relative movement and thus the relative rate of rotation between drive ring 12 and take-off ring 13 the friction-type free-wheeling mechanism will be in the disengaged or locked engaged state in which the friction-type clamping elements 14a, 14b, 14c . . . take on a different orientation.

The disengaged state and the locked state are shown in FIGS. 3B and 3C, respectively, and are described below.

FIG. 3B shows the friction-coupling free-wheeling mechanism of FIG. 3A in its disengaged state in which drive ring 12 rotates at a lower speed than take-off ring 3, thus displaying a negative movement relative to take-off ring 13. In this situation, friction elements 14a, 14b, and 14c will orient themselves in a manner whereby their smaller diameter is exposed between drive ring 12 and take-off ring 13, thus decoupling the movement of take-off ring 13 from that of drive ring 12.

FIG. 3C depicts the friction-coupling free-wheeling mechanism of FIG. 3A in its locked state. In this case, drive ring 12 rotates at a greater speed than take-off ring 13, causing friction elements 141, 14b and 14c to orient themselves in a way as to increase the diameter between drive ring 12 and take-off ring 13, thus creating a positive connection by way of which the torque of drive ring 12 can be transferred to take-off ring 13.

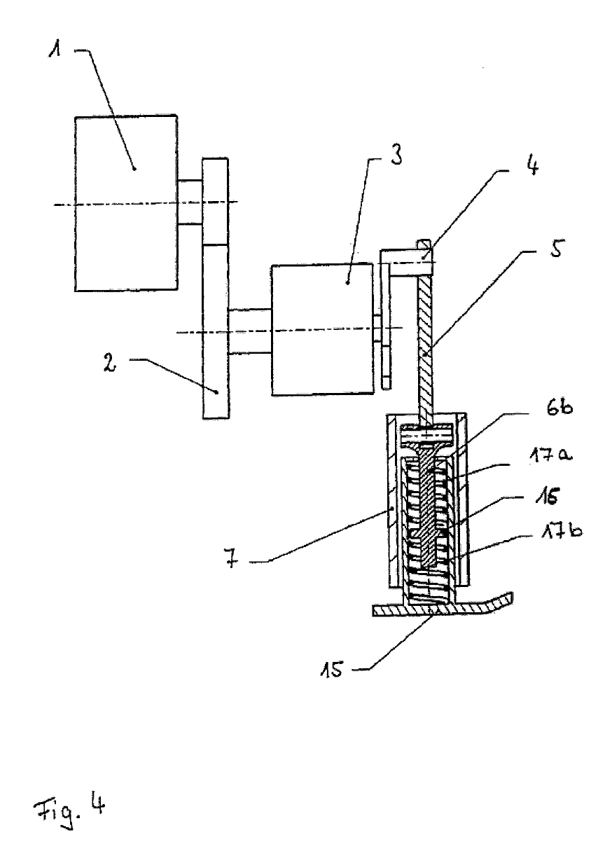

FIG. 4 shows a tamper with free-wheeling mechanism and a dual-action helical spring. The functionalities of motor 1, gear system 2, free-wheeling mechanism 3, crank gear 4 and connecting rod 5 are the same as described above and are not described again.

The tamper shown in FIG. 4 incorporates a ramming piston 15 equipped at its lower end with a rammer plate or rammer butt. The tamper may be employed for purposes such as soil compaction.

In addition, the tamper includes an elongated driver element 6b that is linked to a connecting rod 5 and is partially set in a cavity of ramming piston 15 in a way as to allow driver element 6b and ramming piston 15 to move linearly relative to each other along a common central axis.

Inside the cavity of ramming piston 15, driver element 6b features a collar 16 that serves as a retaining device and to which it is connected between two helical springs 17a and 17b provided in the cavity of ramming piston 15. Helical springs 17a, 17b are aligned along the common center axis of ramming piston 15 and driver element 6b and can be in contact with front faces of the cavity of ramming piston 15. This allows helical springs 17a, 17b to elastically transfer an axial relative movement of driver element 6b and ramming piston 15. Helical springs 17a, 17b can thus efficaciously transfer the kinetic energy between driver element 6b and ramming piston 15.

Alternatively, helical springs 17a, 17b may be replaced by only one helical spring which in a central region of its longitudinal axis can be coupled to the driver element.

In the tamper shown in FIG. 4, as in the case of the percussion assembly per FIG. 2 with dual pneumatic springs, it is possible for free-wheeling mechanism 3, upon acceleration of ramming piston 15 through a kick-back transmitted to ramming piston 15 via the rammer butt, to interrupt the torque flow between motor 1 and driver element 6b, thus allowing ramming piston 15 to freely accelerate driver element 6b.

Moreover, the movement of drive element 6b can be decoupled from motor 1 when ramming piston 15 is traveling with high kinetic energy in the direction of the rammer butt while accelerating driver element 6b by compressing the first helical spring 17a. This will prevent ramming piston 15 from being slowed down by a coupling to the torque flow of the drive unit just before the rammer butt strikes.

In the tamper depicted in FIG. 4, with free-wheeling mechanism and a dual-action helical spring, the recoil energy produced by the kick-back can thus be used in preparing the next ramming cycle, increasing the number of tamping strokes with an unchanged rotational speed of the motor.

1. An, implement, comprising:
a drive unit;
a driver element axially movable by the drive unit;
a motion element axially movable and linked to the driver element via a coupling; and
an overrunning clutch positioned in the drive unit or in a torque flow between the drive unit and the driver element; wherein
the overrunning clutch is engaged in a locked state when the drive unit moves at a speed greater than or equal to that of the driver element, and in a disengaged state when the drive unit moves at a speed slower than that of the driver element; and wherein
the torque flow between the drive unit and the driver element is closed in the locked state and interrupted in the disengaged state of the overrunning clutch.

2. The implement as recited in claim 1, wherein
the drive unit is a rotary drive; and further comprising
a rotation conversion device, provided in the torque flow between the rotary drive and the driver element, for converting a rotation of the rotary drive into an oscillating translatory movement of the driver element.

3. The implement as recited in claim 2, wherein
the overrunning clutch is positioned in the torque flow between the rotary drive and the rotation conversion device.

4. The implement as recited in claim 1 , wherein a spring element, serving as a coupling device, is positioned between the driver element and the motion element.

5. The implement as recited in claim 1, wherein the overrunning clutch is constituted of a free-wheeling mechanism.

6. The implement as recited in claim 5, wherein the free-wheeling mechanism comprises at least one of a friction-clamp coupling, a pinch-roller coupling, a ratchet coupling, and a gear coupling.

7. The implement as recited in claim 1, wherein
the overrunning clutch is incorporated in the drive unit;
the drive unit can be controlled in a manner in which it cannot function as a generator when it is in an operating state during which a drive shaft of the drive unit is rotated from the outside.

8. The implement as recited in claim 1, wherein the motion element is a percussion piston.

9. The implement as recited in claim 8, wherein the spring element is composed of at least one pneumatic spring resulting from a relative movement between the driver element and the percussion piston.

10. The implement as recited in claim 9, further comprising an impact element that can be impacted by the percussion piston.

11. The implement as recited in claim 10, wherein a tool is attached to the impact element.

12. The implement as recited in claim 1, wherein the motion element is a ramming piston.

13. The implement as recited in claim 12, wherein the spring element comprises at least one of a helical spring, a gas-pressure spring, and an elastomer spring.

14. The implement as recited in claim 13, wherein the ramming piston is provided with a cavity accommodating a helical spring which is coupled to the driver element.
